(19) United States
(12) Patent Application Publication
(10) Pub. No.: US 2026/0065656 A1
(43) Pub. Date: Mar. 5, 2026

(54) COAL GANGUE RECOGNITION METHOD BASED ON VISIBLE-NEAR-INFRARED SPECTRUM AND IMAGE MULTI-MODAL INFORMATION FUSION

(71) Applicant: Taiyuan University of Technology, Taiyuan City (CN)

(72) Inventors: Bo LI, Taiyuan City (CN); Xiaoyu Li, Taiyuan City (CN); Xiang Wang, Taiyuan City (CN); Jiahao Ma, Taiyuan City (CN); Rui Xia, Taiyuan City (CN); Juanli Li, Taiyuan City (CN); Xuewen Wang, Taiyuan City (TW)

(21) Appl. No.: 19/027,675

(22) Filed: Jan. 17, 2025

(30) Foreign Application Priority Data
Aug. 27, 2024 (CN) 202411182206.0

(51) Int. Cl. G06V 10/80; G06V 10/60; G06V 10/62; G06V 10/764; G06V 10/77; G06V 10/776; G06V 10/82; G06V 20/10

(52) U.S. Cl. CPC G06V 10/806; G06V 10/60; G06V 10/62; G06V 10/764; G06V 10/7715; G06V 10/776; G06V 10/82; G06V 20/194

(57) ABSTRACT

The present invention belongs to the technical field of coal gangue recognition and sorting, and in particular, relates to a coal gangue recognition method based on visible-near-infrared spectrum and image multi-modal information fusion. The method includes: S1 collecting spectral information and image information about a sample to be recognized; S2 preprocessing the spectral information and the image information respectively; S3 extracting spectral features from a spectral data set by using a spectral feature extraction neural network model; and extracting image features from an image data set by using an image feature extraction neural network model; S4 inputting the spectral features and the image features obtained from feature extraction into a two-stream fusion network; S5 inputting extracted spectral features, extracted image features and a comprehensive feature into a spectral branch classifier, an image branch classifier and a fusion branch classifier, respectively; S6 calculating importance weights of a spectral branch, an image branch and an image-spectrum fusion branch; and S7 subjecting the importance weights and corresponding confidence to multiply-accumulate operation to obtain a score matrix of coal gangue, and using the score matrix to achieve coal gangue recognition.

### TECHNICAL FIELD

The present invention belongs to the technical field of coal gangue recognition and sorting, and in particular, relates to a coal gangue recognition method based on visible-near-infrared spectrum and image multi-modal information fusion.

### BACKGROUND

China is a large country for energy production and consumption, and the high-quality development of energy is a basic guarantee for the long-term and steady growth of national economy. During modern mechanical mining, due to the limitation of the mining environment, raw coal generally contains a large amount of gangue, and the increase of the gangue content will greatly reduce the quality of the raw coal, leading to the low utilization efficiency of coal and the generation of more pollutant emissions. It is internationally recognized that coal sorting is a preferred scheme for achieving efficient and clean utilization of coal. The technology of coal gangue sorting will become an important technical support for the development of the coal industry, and will be popularized comprehensively in 2035, thereby achieving intelligent, safe and accurate coal mining, and facilitating the innovative development of the main energy science and technology in China.

Traditional coal gangue sorting mainly relies on the experience of sorting workers themselves, and although the method is simple to operate, the method is highly susceptible to individual factors of workers, and has high work intensity and low efficiency of gangue sorting. Limited by the problem of low precision of raw coal sorting in a traditional dry sorting method, a wet sorting method is mainly used to sort the raw coal at present in China, but there are many problems such as high energy consumption for gangue crushing, waste of water resources, and low lump coal percentage. In recent years, the usability of a method based on spectral analysis and image recognition is improved due to its advantages of fast and nondestructive detection, but spectral data and image data are highly susceptible to optical system parameters, and it is difficult to deal with the actual abnormal working conditions of coal slime coating and coal gangue stacking.

To solve the above problems, we propose an intelligent coal gangue recognition method based on visible-near-infrared spectrum and image multi-modal information fusion, information about two different information sources, i.e., a spectrum and an image, is processed, analyzed, integrated and inferred, and preprocessing, feature extraction, feature fusion, pattern matching and decision fusion are performed on spectral features and image features of coal gangue, finally achieving coal gangue recognition under a severe working condition.

In the present era of information explosion, we are faced with the challenge of mass data and diversified information, a single information source often cannot meet our comprehensive understanding and decision requirements for problems, spectral and image information is fused at multiple angles and multiple levels by a neural network fusion algorithm, and the association hidden between various types of information is revealed, thereby generating more comprehensive and comprehensive knowledge to provide more comprehensive, accurate and reliable results.

### SUMMARY

To solve the above problems, the present invention provides a flight conveyor testing platform based on a similarity theory and a testing method.

The present invention adopts the following technical solutions: a coal gangue recognition method based on visible-near-infrared spectrum and image multi-modal information fusion, including:
S1: collecting spectral information and image information about a sample to be recognized;
S2: preprocessing the spectral information and the image information respectively, and constructing an image-spectrum data set with spectra and images having a one-to-one correspondence relationship to acquire model priori knowledge, the image-spectrum data set comprising a spectral data set and an image data set;
S3: extracting spectral features from the spectral data set by using a spectral feature extraction neural network model; and extracting image features from the image data set by using an image feature extraction neural network model;
S4: inputting the spectral features and the image features obtained from feature extraction into a two-stream fusion network to output a comprehensive feature;
S5: inputting extracted spectral features, extracted image features and the comprehensive feature into a spectral branch classifier, an image branch classifier and a fusion branch classifier, respectively, to obtain class confidence under three classifiers;
S6: calculating importance weights of a spectral branch, an image branch and an image-spectrum fusion branch; and
S7: subjecting the importance weights and corresponding confidence to multiply-accumulate operation to obtain a score matrix of coal gangue, and using the score matrix to achieve coal gangue recognition.

In some embodiments, in step S1, spectral information about a sample surface is collected by using a fiber optic probe, a halogen lamp and a spectrometer are turned on for preheating before the spectral information about a sample is collected, spectral information with a polytetrafluoroethylene white sheet and during probe covering is collected first for data processing, spectral information about three positions, i.e., a front part, a middle part and a tail part, of each sample is collected, and an average spectrum of the three positions is taken as spectral information about the sample; and
image information about the sample is collected by using an industrial lens, and the image information is in one-to-one correspondence with the spectral information.

In some embodiments, in step S2,
preprocessing the spectral information includes:
sequentially subjecting to existing technical processing of black and white correction, initial and final band elimination, SG smoothing and standard normal variate transformation; and
preprocessing the image information includes:
uniformly adjusting an image size, converting an image with an adjusted size into a tensor format, and performing standardization processing on the image.

In some embodiments, in step S2, preprocessed spectral features and image features are in one-to-one correspondence, and are encapsulated together with labels in TensorDataset.

In some embodiments, in step S3,
the spectral feature extraction neural network model includes:
a recurrent neural network branch, including: an LSTM layer, a batch normalization layer, and an expansion layer, wherein the spectral information is sequentially subjected to the LSTM layer and the batch normalization layer for expansion to obtain spectral sequence features; and
a convolutional neural network branch, including: a one-dimensional convolutional layer, a maximum pooling layer, and a Dropout layer, wherein the spectral information is subjected to the one-dimensional convolutional layer, the maximum pooling layer and the Dropout layer to obtain spectral convolutional features,
wherein the spectral sequence features and the spectral convolutional features are subjected to Concat operation for fusion and then input into a second convolutional layer and a Relu layer to obtain the spectral features.

In some embodiments, in step S3,
the image feature extraction neural network model includes convolutional blocks, 17 inverted residual blocks, and a convolutional block cascade, each convolutional block includes a two-dimensional convolutional layer, a batch normalization layer, and a Relu6 layer, and each inverted residual block includes a lightweight dilated convolution layer, a depthwise separable convolution layer, and a pointwise convolution layer.

In some embodiments, in step S4, the two-stream fusion network includes:
a first convolutional branch, including: a convolutional layer, a batch normalization layer, and a convolutional layer, wherein the spectral features are input into the first convolutional branch, and spectral feature 1 is output;
a second convolutional branch, including: a convolutional layer, a batch normalization layer, and a convolutional layer, wherein the image features are input into the second convolutional branch, and image feature 1 is output;
a third convolutional branch, including: a convolutional layer and a batch normalization layer, wherein the spectral features are input into the third convolutional branch, and spectral feature 2 is output;
a fourth convolutional branch, including: a convolutional layer, a batch normalization layer, and an average pooling layer, wherein the image features are input into the fourth convolutional branch, and image feature 2 is output; and
a self-attention mechanism, wherein the spectral feature 2 and the image feature 2 are subjected to the self-attention mechanism to obtain weight distribution of original features in a fusion feature space,
wherein the spectral feature 2 and the image feature 2 are subjected to multiplicative fusion to obtain fusion feature 1, the spectral feature 2 and the image feature 2 are used to be respectively subjected to multiplicative fusion with the fusion feature 1, concatenation operation is then performed, normalization is performed in a global feature, a normalized feature weight is used to be respectively multiplied by the spectral feature 1 and the image feature 1 to obtain a spectral weight feature and an image weight feature under guidance of the fusion feature space, and two modal weight features are subjected to additive fusion to obtain the comprehensive feature which is then subjected to convolution processing once to obtain a deeper-layer comprehensive feature.

In some embodiments, in step S5:
the spectral branch classifier includes: a fully connected layer and a Sigmoid layer;
the image branch classifier includes: an adaptive average pooling layer and a 1*1 convolutional layer; and
the fusion branch classifier includes: two fully connected layers connected, wherein an activation function is Relu.

In some embodiments, step S6 includes:
training, based on the image-spectrum data set, a neural network model constituted by the spectral feature extraction neural network model, the image feature extraction neural network model, the two-stream fusion network, the spectral branch classifier, the image branch classifier and the fusion branch classifier to obtain accuracy rates, F1 values and root-mean-square errors under the spectral branch classifier, the image branch classifier and the fusion branch classifier, which are taken as priori knowledge;
constructing a target layer, an index layer and a scheme layer according to coal gangue sorting requirements and scenarios, wherein the target layer is for coal gangue sorting, the index layer is for classed accuracy rates, F1 values and root-mean-square errors, and the scheme layer is for the spectral branch classifier, the image branch classifier and the fusion branch classifier;
judging importance of each index in the index layer relative to a task according to scenarios and requirements of the task, thereby formulating a judgment matrix between the target layer and the index layer to finally obtain a 3×3 judgment matrix, wherein a judgment matrix element Dᵢⱼ represents an importance degree of an ith-row factor relative to a jth-column factor, the larger a numerical value thereof is, the more important a factor is, and row and column factors are the accuracy rates, the F1 values and the root-mean-square errors, respectively;
dividing the priori knowledge, i.e., the accuracy rates, the F1 values and the root-mean-square errors under the spectral branch classifier, the image branch classifier and the fusion branch classifier, into 9 sections on average according to a maximum value and a minimum value of each index, wherein the closer an index of a classifier is to an optimal value, the larger a quantization value, representing the importance degree of the index of an ith-row classifier relative to a jth-column classifier, and row and column classifiers represent the spectrum branch classifier, the image branch classifier and the fusion branch classifier, respectively; and performing operations above on each index to finally obtain three 3×3 judgment matrices;
obtaining factor weight matrices between the target layer and the index layer as well as between the index layer and the scheme layer by calculation using an eigenvalue method according to the judgment matrices, and constituting a final classifier weight matrix by the factor weight matrices; and
checking whether the judgment matrices pass consistency check, if yes, subjecting a first column and last three columns of the final classifier weight matrix to multiply-accumulate operation correspondingly to obtain an importance weight of each classifier, and if not, verifying that the judgment matrices are set incorrectly, and reconstructing judgment matrices.

In some embodiments, step S7 includes:
subjecting three class confidence matrices output by the spectrum branch classifier, the image branch classifier and the fusion branch classifier and a classifier weight matrix to multiply-accumulate operation to finally obtain scores predicted to be coal and gangue, thereby achieving coal gangue recognition.

Compared with the prior art, the present invention has the following beneficial effects:
1) The spectral feature map is extracted from collected spectral data of coal gangue samples by LSTM-CNN, and the wavelength dependency relationship and local features in the data are simultaneously captured by combining two different types of neural network structures, i.e., LSTM and CNN, to fully extract feature information in the spectral data, thereby improving the understanding and analysis capability of a model on the spectral data;
2) Image data features are extracted by a MobilNetV2 network, which has advantages such as light weight, high inference speed, and high performance;
3) The spectral features and the image features are matched in a dimensional shape by the operation of transpose-multiplying of spectral one-dimensional data, to better fuse feature information about different branches;
4) Complementary fusion is performed on the two extracted modal feature maps by a two-stream branch fusion module, feature representations of the different scales are captured under the guidance of different scales, and compared with a simple fusion mode, such a two-stream guidance fusion is more efficient;
5) By introducing the modal self-attention mechanism, the method uses the features obtained by multiplicative fusion of spectra and images to guide feature weights of the spectra and the images, the correlation and importance between different modal data are effectively learned, and the model is better guided to pay attention to important information, thereby reducing information redundancy;
6) The importance weights of the spectral branch classifier, the image branch classifier and the fusion branch classifier are calculated by an analytic hierarchy process, so that the overall grasp and processing capability of the model on a task is improved, and the model is guided to more accurately pay attention to and use information about each branch to improve the robustness of the model against data noise and interference, thereby enabling the model to be more stable and reliable.

According to the present invention, composite fusion is performed on the spectral information and the image information based on a multi-modal information fusion technology, and feature fusion improves the recognition performance of the model, so that the problem of low recognition precision due to severe and complex working conditions such as large underground coal dust, poor lighting conditions and noise interference can be effectively solved. Decision fusion improves the stability and adaptability of the model, so that the problem of misrecognition due to single modal information one-sidedness under abnormal working conditions such as coal slime coating can be solved. The method provides a technical basis for underground coal gangue sorting and in-situ filling, which is not only beneficial to resource utilization and environmental protection, but also improves the safe production and economic benefits of a mine.

### BRIEF DESCRIPTION OF THE DRAWINGS

FIG. 1 is a flowchart of coal gangue multi-modal information fusion recognition;

FIG. 2 is a schematic diagram of a structure for collecting visible-near-infrared spectrum and image information;

FIG. 3 is a spectral preprocessing diagram;

FIG. 4 is a spectral feature extraction branch;

FIG. 5 is a core inverted residual structure of an image feature extraction branch;

FIG. 6 is a two-stream guidance feature fusion structure;

FIG. 7 is a hierarchical structure model;

FIG. 8 is a flowchart of multi-branch weight calculation based on an analytic hierarchy process;

Where: 1, Halogen lamp; 2, g Optical fiber support; 3, Fiber optic probe; 4, Fiber optic holder; 5, Industrial camera; 6, Camera support; 7, Spectrometer; 8, Computer.

### DETAILED DESCRIPTION OF THE EMBODIMENTS

To make the objectives, technical solutions, and advantages of the present invention clearer, the following will clearly and completely describe the technical solutions in the present invention in conjunction with the drawings in the present invention. Apparently, the embodiments to be described are a part rather than all of the embodiments of the present invention. Based on the embodiments of the present invention, all the other embodiments got by those of ordinary skill in the art on the premise of not paying creative labor, fall within the scope of the protection of the present invention.

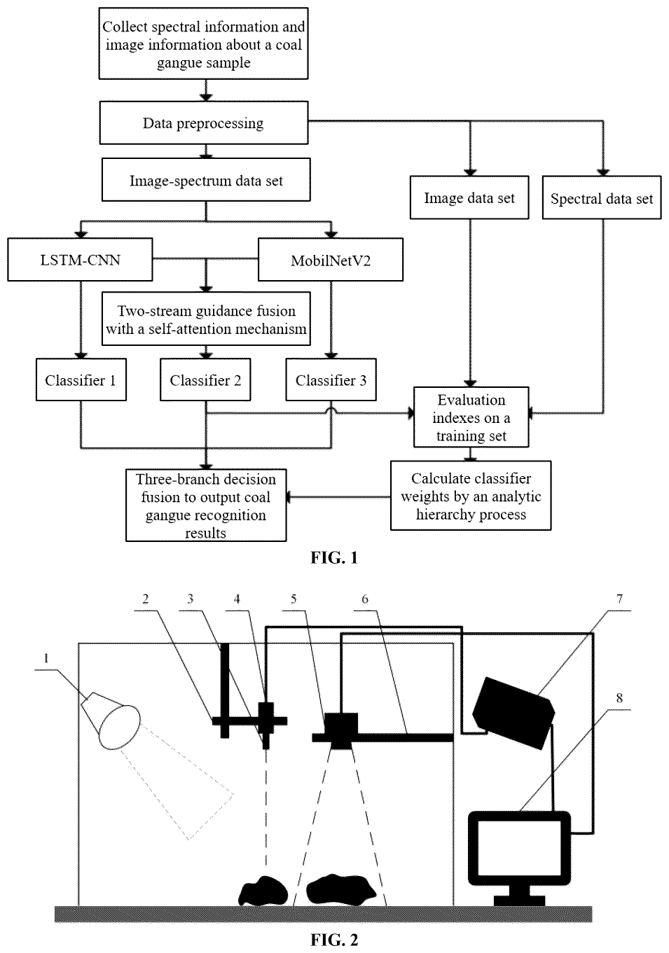

The present invention proposes a coal gangue recognition method for feature fusion and decision fusion based on visible-near-infrared spectrum and image two-modal information, the flowchart thereof is shown in FIG. 1, and the method includes the following steps:

A spectrometer module is a set of device consisting of a spectrometer (USB2000+, Ocean Insight, USA), a fiber optic probe (ISMAIS-SI0.6-1500S, Nanjing Shen Luc Technology Co., Ltd, China), and a halogen lamp (JCR15V150WBAU), intended for collecting spectral intrinsic chemical information about a coal gangue sample. In the module, the spectrometer is responsible for analyzing and processing a spectral signal of the sample, the fiber optic probe is used for collecting spectral data of a sample surface and transmitting same to the spectrometer for further analysis, and the halogen lamp provides a required light source to excite an emission spectrum of the sample.

A machine vision instrument module generally consists of a HIKVISION industry area-array camera (MV-CA050-12UC) and a HIKVISION 8-megapixel industrial lens (MVL-MF0828M-8MP 8 mm), intended for collecting image appearance information about the coal gangue sample. The industrial area-array camera is a high-performance image collecting device, capable of rapidly capturing a high-resolution image and transmitting same to a computer for subsequent processing. The industrial lens is responsible for high-definition imaging of the sample, ensuring the image quality and definition.

A data collecting module: the halogen lamp emits light rays with different wavelengths, the light rays are absorbed and reflected by the sample and then transmitted to the spectrometer by the fiber optic probe, an optical signal is converted into an electrical signal, spectral information is displayed and collected in real time by spectrometer kit software OceanView2.0.7, and the whole system is placed under a light-proof black cloth, reducing interference of external stray light.

The halogen lamp and the spectrometer are turned on for preheating for 20 min before the spectral information about the sample is collected, spectral information with a polytetrafluoroethylene white sheet and during probe covering is collected first for data processing, the wavelength range collected by the spectrometer is 369 to 1049 nm, which relates to 2048 wavelengths, and the integration time is 8 ms.

To prevent reflection spectra from exceeding a detection range of the probe due to an excessive inclination angle of the slope of the sample, in the present invention, spectral information about three positions, i.e., a front part, a middle part and a tail part, of each sample is collected, an average spectrum of the three positions is taken as the spectral information about the sample, and during the collection, the positions and postures of the fiber optic probe and the halogen lamp remain unchanged, and only the sample is translated forwards and backwards.

Machine vision software (MVS) is used to manually operate and control the camera to shoot and store image information about the sample, the resolution of a picture is 2448×2048, the pixel size is 3.45 um, the exposure time is 10 ms, and spectral data corresponds to image data on a one-to-one basis.

The collection by the spectrometer and the shooting by the camera can be triggered by a photoelectric switch, for example, timing starts when a sample to be recognized on a conveyor belt passes, the delay time is calculated by means of the belt speed, the distance between the spectrometer and the photoelectric switch and the distance between the camera and the photoelectric switch, and after the delay time is reached, the collection of the spectral and image data is completed based on Python and the communication between the two collecting devices. In addition, the collection areas of the fiber optic probe and the camera are not required, but the two preferably not collect at the same viewing angle, the fiber optic probe can be placed on the side surface of the conveyor belt to collect the side surface data of the sample, and the camera can be placed above to collect the top image of the sample, which is not specifically defined in the present invention.

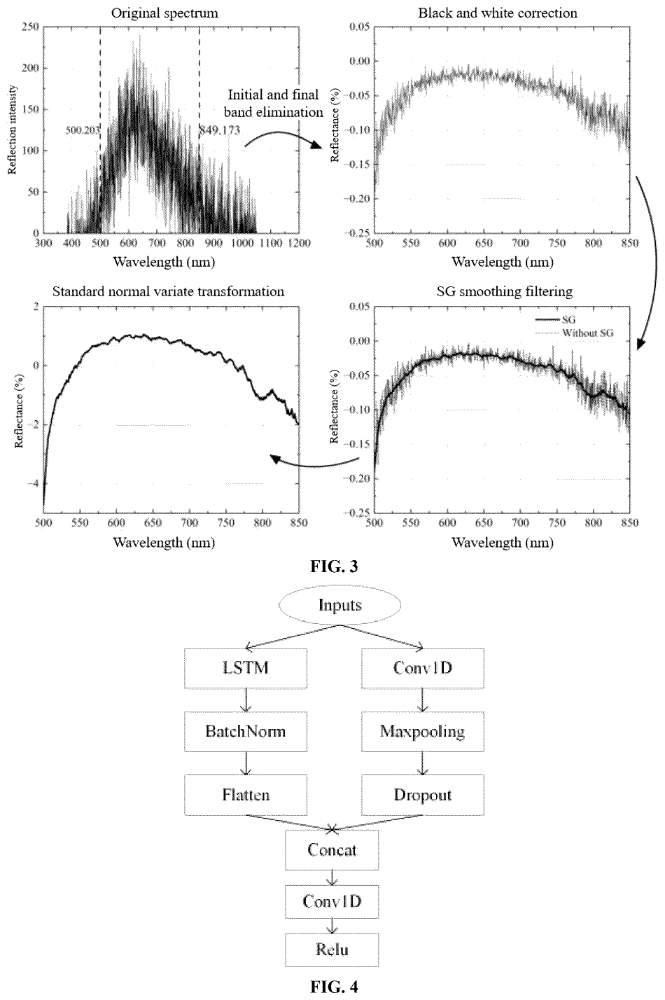

A data processing module: completes noise reduction processing on the spectral data relying on matlab and Python, reducing interference of an instrument, an environment, a background and redundant information on data. As shown in FIG. 3, spectral raw data is sequentially subjected to existing technical processing of black and white correction, initial and final band elimination, SG smoothing and standard normal variate transformation, and then stored in a mat file. For image data, firstly, the image size is uniformly adjusted to 224×224, the image with an adjusted size is then converted into a tensor format, finally, standardization processing is performed on the image, and 0.5 is subtracted from the numerical value of each channel and the result is divided by 0.5, so that the image data is between −1 and 1.

A data set: the above preprocessed spectral data and image data and the labels are converted into a tensor array format to construct an image-spectrum data set, wherein the spectral information in the image-spectrum data set corresponds to the image information on a one-to-one basis. The data set is stored in a TensorDataset including input1, input2 and target, and is divided into a training set, a validation set and a test set in 6:2:2, for which a DataLoader is created respectively, with the batch being set as 16.

A feature extraction module: the module mainly uses a deep learning neural network model to complete more comprehensive and accurate extraction of spectral information and image information features, and consists of spectral-image two-branch feature extraction neural network models, a spectral feature extraction branch consists of an LSTM-CNN network constructed by us, and the network integrates a recurrent neural network based on a CNN network, so that the captured wavelength sequence information can be effectively supplemented. The image feature extraction neural network model consists of a MobilNetV2 network, which has advantages of light weight and high efficiency.

A feature fusion module: two modal features extracted by the two-branch feature extraction neural networks are used as inputs, and a constructed two-stream fusion network is used to enhance the interactive fusion of spectral and image feature representations, to achieve the complementation and strengthening of image-spectrum modal information and form a more comprehensive feature representation, thereby providing a more comprehensive and accurate result, and improving the capability of the model when processing complex tasks. In addition, a modal self-attention mechanism is introduced into the two-stream feature fusion network, so that the weights of the two modal features in a fused feature are distributed, thereby achieving a more flexible feature fusion mode, achieving adaptive weight distribution of features, and enabling the model to more flexibly capture the correlation and importance between different features.

A three-branch decision fusion module: the module firstly decomposes a task nature into different influence factors based on an improved analytic hierarchy process, then, formulates a judgment matrix between layers according to the interaction and membership relationship between factors, calculates a factor weight matrix according to the judgment matrix, calculates importance weights of a spectral branch, an image branch and an image-spectrum fusion branch after the consistency check is passed, subjects the weights and corresponding confidence to multiply-accumulate operation to obtain a score matrix of coal gangue, and uses the score matrix to recognize and evaluate coal gangue, thereby improving the recognition accuracy and reliability of the model by comprehensively considering the importance weights and confidence of different feature branches. In this way, when the quality of data collected by a certain modality is relatively poor, a second modality can still maintain a relatively high weight, thereby not affecting the recognition precision; and when both modalities are affected relatively highly, a fusion modality exerts a main function thereof.

The data processing module preprocesses collected spectral information, to reduce influences of a device, an environment and a background. As shown in FIG. 3, the data processing module specifically includes the following components:

Black and white correction: the collected spectral data of a white reference (polytetrafluoroethylene standard white sheet) with a reflectance close to 100% and the collected spectral data of a black reference (probe covering) with a reflectance close to 0% are used to correct the spectral data, so that the reflection intensity of the whole spectrum is normalized to a unified standard, eliminating the brightness difference due to the uneven light source intensity and the interference of the instrument dark current. The relative reflectance is specifically:

$$R = \frac{{I}_{origin} - {I}_{black}}{{I}_{white} - {I}_{black}}$$

where R is the relative reflectance of the sample, I_{origin} is the reflection spectrum intensity of the sample, I_{white} is the reflection spectrum intensity of the white reference, and I_{black} is the reflection spectrum intensity of the black reference.

Initial and final band elimination: due to the influence of factors such as noises of an instrument or environmental interference, the initial and final band data are removed, and the spectrum of the 500 to 850 nm band is retained for analysis, thereby improving the quality and accuracy of the data, and making the analysis result more reliable.

SG smoothing: using a Savitzky-Golay algorithm, based on local polynomial fitting, signal smoothing is achieved by performing convolution operation on a sliding window of a spectrum, a sliding window with a suitable size is selected, the size of the window is usually an odd number, noises and mutations in the spectral data are removed, and main trends and features of the data are retained, thereby improving the quality and readability of the data. In the present invention, a polynomial fitting order used is 1, i.e., linear fitting, and the size of the sliding window is 21, i.e., 10 data points are respectively taken on the left and right sides of each data point for fitting. The size of the sliding window here is determined by a specific spectral curve, which is not required in the present invention.

Standard normal variate transformation: the algorithm performs mean centering and standard deviation standardization on the spectrum of the sample at each wavelength point, to achieve standard normal variate transformation.

The mean centering is to subtract the mean value of the spectral data of all the samples at the wavelength point, to make the mean value of the spectral data zero, and the standard deviation standardization is to divide the data by the standard deviation thereof, to make the spectral data at each wavelength point have the same scale.

The method can eliminate the deviation and amplitude difference of the overall spectrum, highlighting information related to the chemical compositions of the sample, and enabling to effectively eliminate the influences of surface scattering, solid particle size and optical path change on the spectrum. The specific calculation is as follows:

$$\overline{x} = \frac{{\sum }_{k = 1}^{m} {x}_{k}}{m}$$

$${x}_{snv} = \frac{x - \overline{x}}{\sqrt{\frac{{\sum }_{k = 1}^{m} {( {x}_{k} - \overline{x} )}^{2}}{m - 1}}}$$

where m is the number of wavelength points, k=1, 2, 3, . . . , m.

The feature extraction module extracts high-level features in the spectrum and image information based on each feature extraction branch, and specifically includes the following components:

An LSTM-CNN network: a spectral feature extraction branch LSTM-CNN consists of a recurrent neural network and a convolutional neural network. As shown in FIG. 4, spectral information in a recurrent neural network branch is subjected to an LSTM layer, a batch normalization layer and an expansion layer to obtain spectral sequence features. Spectral information in a convolutional neural network branch is subjected to a one-dimensional convolutional layer, a maximum pooling layer, and a Dropout layer to obtain spectral convolutional features. Then, the two features are subjected to Concat operation for fusion and then input into a second convolutional layer and a Relu layer to finally obtain the spectral features.

A MobilNetV2 network: the image feature extraction branch is implemented by the MobilNetV2 network, a feature extraction layer of the network consists of convolutional blocks, 17 inverted residual blocks, and a convolutional block cascade, each convolutional block includes a two-dimensional convolutional layer, a batch normalization layer, and a Relu6 layer, and each inverted residual block consists of a lightweight dilated convolution layer, a depthwise separable convolution layer, and a pointwise convolution layer, as shown in FIG. 5.

A feature matching module: the features extracted by the designed parallel two-branch feature extraction networks do not match in dimension and shape, the extracted spectral sequence features are subjected to transpose-multiplying operation to be converted into a two-dimensional matrix and then subjected to the convolution layer to implement channel increasing, and the image features are subjected to down-sampling and global average pooling to implement matching of spectral information and image information in space and channel dimensions, thereby achieving effective feature fusion.

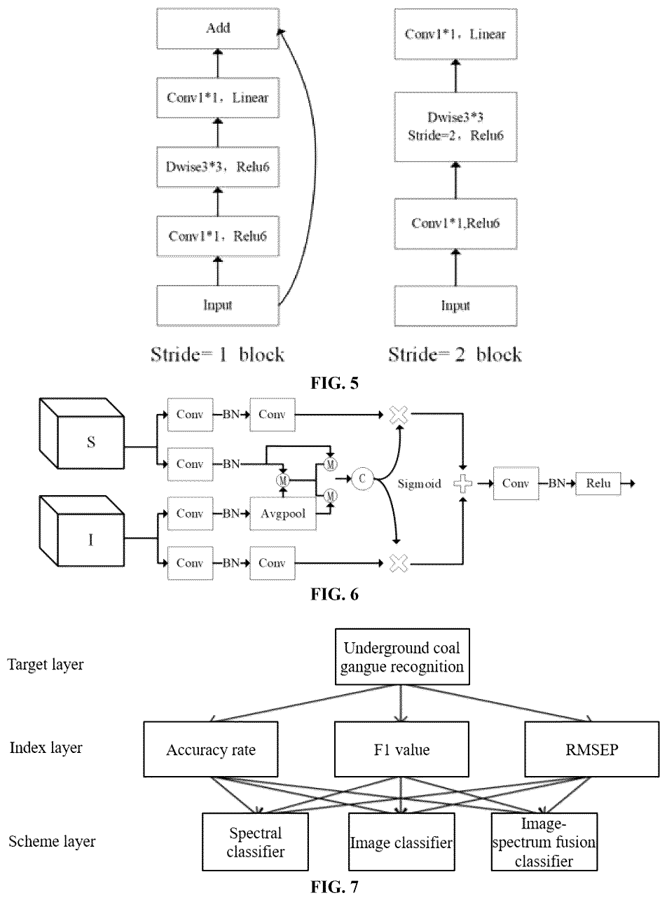

The feature fusion module implements the high-efficiency interaction between the spectral information and the image information based on a bilateral guidance fusion module of a semantic segmentation network BiSeNetV2, and the self-attention mechanism is added inside the module, thereby better capturing the correlation between features, and enhancing the association learning capability of the model on different features. As shown in FIG. 6, the feature fusion module specifically includes the following components:

A bilateral guidance fusion module: the module inputs the input spectral and image features into the two convolutional branches respectively by using a module for fusing detail branch and semantic branch features in BiSeNetV2, and the two features are subjected to the convolutional layer, the batch normalization layer and the convolutional layer to obtain spectral feature 1 and image feature 1 in a deeper layer; on the other hand, the spectral features are subjected to the convolutional layer and the batch normalization layer to obtain spectral feature 2, the image features are subjected to the convolutional layer, the batch normalization layer and the average pooling layer to obtain image feature 2, the spectral feature 2 and the image feature 2 are subjected to the self-attention mechanism to obtain weight distribution of original features in a fusion feature space, and the weight distribution and the spectral feature 1 as well as the image feature 2 are subjected to multiply-accumulate operation to obtain an image-spectrum fusion feature map.

A self-attention mechanism: the mechanism implements the distribution of the weights of the spectral features and the image features in the fusion feature space, so that the model better learns the correlation between features. The spectral feature 2 and the image feature 2 are subjected to multiplicative fusion to obtain fusion feature 1, the spectral feature 2 and the image feature 2 are used to be respectively subjected to multiplicative fusion with the fusion feature 1, concatenation operation is then performed, normalization is performed in a global feature, and a normalized feature weight is used to be respectively multiplied by the spectral feature 1 and the image feature 1 to finally obtain modal weight features under guidance of the fusion feature space, thereby implementing the self-attention mechanism when the two modal features are fused.

The three-branch decision fusion module inputs the spectral feature extraction branch, the image feature extraction branch and the feature fusion branch into classifiers, to achieve three-branch coal gangue recognition. The weight of each classifier is calculated based on the analytic hierarchy process and the priori knowledge, to achieve decision fusion recognition of coal gangue. The three-branch decision fusion module specifically includes the following components:

Classifiers: a spectral branch classifier consists of a fully connected layer and a Sigmoid layer, an image branch classifier is implemented by an adaptive average pooling layer and a 1*1 convolutional layer, and a fusion branch classifier consists of two fully connected layers connected, wherein an activation function is Relu.

Priori knowledge: according to task requirements, a judgment matrix between a target layer and an index layer is constructed by combining subjective judgment with expert opinions and data analysis results. According to performance indexes of each model in a spectral data set, an image data set and an image-spectrum data set, the importance of pairwise factors at the same level relative to a factor at a previous level is quantitatively expressed, to construct a judgment matrix between an index layer and a scheme layer. The evaluation indexes selected in the method include an accuracy rate, an F1 value and a root-mean-square error, the accuracy rate measures the proportion of models correctly classified in all the prediction samples, and the F1 value is a comprehensive consideration for the accuracy rate and recall rate of the models; in addition, the root-mean-square error between the probability of the class to which the prediction samples belong and a true class is used as a reliability index of the models, and the number and types of the evaluation index are not required, and are set as required by the task.

An analytic hierarchy process: the analytic hierarchy process decomposes a complex decision problem into a series of relatively simple hierarchical structures, and then compares and evaluates the hierarchies to obtain the relative weight of an underlying scheme to a top-level target, and the steps include construction of a hierarchical structure, construction of a judgment matrix, calculation of a weight, consistency check, and comprehensive decision, as shown in FIG. 8.

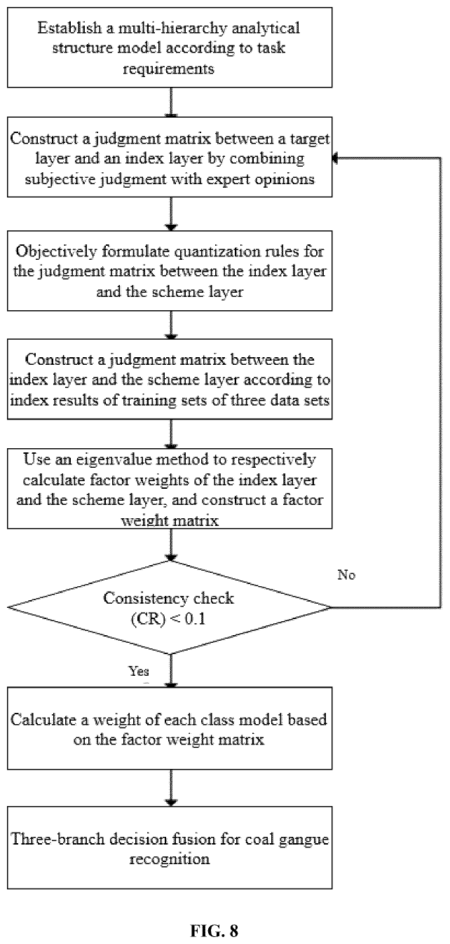

The model requirements of underground coal gangue recognition are analyzed to set a hierarchical structure model of the task, as shown in FIG. 7, the target is for underground coal gangue recognition, the evaluation indexes include an accuracy rate, an F1 value, and a root-mean-square error, and the scheme is for a spectral classifier, an image classifier, and a fusion classifier.

Then, the importance of pairwise factors in the index layer relative to the task of coal gangue sorting is compared, a judgment matrix between the target layer and the index layer is constructed as

$$( \begin{matrix}1 & 3 & 5 \\ 1 / 3 & 1 & 2 \\ 1 / 5 & 1 / 2 & 1\end{matrix} ) ,$$

where a judgment matrix element Dᵢⱼ represents an importance degree of an ith-row factor relative to a jth-column factor, the larger the numerical value thereof is, the more important the factor is, row and column factors are the accuracy rates, the F1 values and the root-mean-square errors, respectively. This means that in the task, we consider the accuracy rate as the most important index, followed by the F1 value, and the root-mean-square error as the least important.

To avoid subjective speculation, we have formulated quantitative rules for the judgment matrix between the index layer and the scheme layer, as shown in the following table:

Rules for quantization values of judgment matrix between index layer and scheme layer

| [symbol] | [symbol] |
|---|---|
| [ Aₘᵢₙ, Aₘᵢₙ + m] | 1 |
| [Aₘᵢₙ + m, Aₘᵢₙ + 2m] | 2 |
| [Aₘᵢₙ + 2m, Aₘᵢₙ + 3m] | 3 |
| . . . | . . . |
| [Aₘᵢₙ + (n − 1)m, Aₘᵢₙ + n × m] | n |
| . . . | . . . |
| [Aₘᵢₙ + 8m, Aₘₐₓ] | 9 |
| [symbol] | a [symbol] = 1/a [symbol] |

[symbol]

indicates data missing or illegible when filed

Compare index Aᵢ with Aₘₐₓ
Quantization value

### Reciprocal

where A is a set consisting of evaluation indexes under three classifiers, Aₘᵢₙ and Aₘₐₓ are the minimum value and the maximum value in the set, and m is

$$\frac{{A}_{max} - {A}_{min}}{9} .$$

According to the above quantization rules for the judgment matrix, the judgment matrices between the scheme layers under three indexes are constructed in sequence, and then the factor weights are calculated from four judgment matrices. In this method, an eigenvalue method is used for calculation, eigenvector normalization corresponding to the maximum eigenvalue of the judgment matrix is a factor weight matrix, the column factor weight matrices of the target layer and the index layer constitute the first column of the final weight matrix, and the three row factor weight matrices of the index layer and the scheme layer constitute the last three columns of the final weight matrix, wherein the first column represents the weight of the index to the task, and the last three columns represent the weight of each classifier to the index, respectively.

The rationality of setting of the judgment matrix is validated by consistency check, and when consistency ratio (CR)<0.1, the consistency check is passed, indicating that the setting of the judgment matrix is reasonable; otherwise, the judgment matrix needs to be corrected. The calculation mode is shown in the following formula

$$CI = \frac{{λ}_{max} - n}{n - 1}$$

$$CR = \frac{CI}{RI}$$

where λₘₐₓ is the maximum eigenvalue of the judgment matrix, and n is the order of the judgment matrix. The consistency index is obtained by looking up the following table:

| n | 1 | 2 | 3 | 4 | 5 | 6 | 7 | 8 |
|---|---|---|---|---|---|---|---|---|
| RI | 0 | 0 | 0.52 | 0.89 | 1.12 | 1.26 | 1.36 | 1.41 |

After the consistency check is passed, data of a first column and last three columns of a final weight matrix are subjected to multiply-accumulate operation correspondingly to obtain the weight of each classifier.

During application, the class confidence matrices under the three classifiers obtained by the three branch neural networks and the classifier weights are subjected to multiply-accumulate operation correspondingly to obtain scores finally predicted to be coal or gangue, thereby achieving coal gangue recognition.

According to the coal gangue recognition method provided by the present invention, the computer applies the reflection spectra and images collected by the spectrometer and the camera for feature fusion and decision fusion to achieve coal gangue recognition, the feature fusion improves the accuracy of coal gangue recognition, and the decision fusion enhances the stability of coal gangue recognition. In addition, the fusion module is constructed to achieve high-quality interaction between image and spectrum modalities, the classifier weights are objectively and scientifically calculated through the improved analytic hierarchy process, and multiple classifiers are effectively combined, thereby enhancing robustness, and achieving better recognition effects on coal gangue sorting and abnormal working conditions in severe environments.

The above description is not a limitation to the present invention, and the present invention is not limited to the above embodiments. Changes, improvements, additions, or substitutions made by those skilled in the art within the essential scope of the present invention also fall within the scope of protection of the present invention.

1. A coal gangue recognition method based on visible-near-infrared spectrum and image multi-modal information fusion, comprising:
S1: collecting spectral information and image information about a sample to be recognized;
S2: preprocessing the spectral information and the image information respectively, and constructing an image-spectrum data set with spectra and images having a one-to-one correspondence relationship to acquire model priori knowledge, the image-spectrum data set comprising a spectral data set and an image data set;
S3: extracting spectral features from the spectral data set by using a spectral feature extraction neural network model; and extracting image features from the image data set by using an image feature extraction neural network model;
S4: inputting the spectral features and the image features obtained from feature extraction into a two-stream fusion network to output a comprehensive feature;
S5: inputting extracted spectral features, extracted image features and the comprehensive feature into a spectral branch classifier, an image branch classifier and a fusion branch classifier, respectively, to obtain class confidence under three classifiers;
S6: calculating importance weights of a spectral branch, an image branch and an image-spectrum fusion branch; and
S7: subjecting the importance weights and corresponding confidence to multiply-accumulate operation to obtain a score matrix of coal gangue, and using the score matrix to achieve coal gangue recognition.

2. The coal gangue recognition method based on visible-near-infrared spectrum and image multi-modal information fusion according to claim 1, wherein in step S1, spectral information about a sample surface is collected by using a fiber optic probe, a halogen lamp and a spectrometer are turned on for preheating before the spectral information about a sample is collected, spectral information with a polytetrafluoroethylene white sheet and during probe covering is collected first for data processing, spectral information about three positions, i.e., a front part, a middle part and a tail part, of each sample is collected, and an average spectrum of the three positions is taken as spectral information about the sample; and
image information about the sample is collected by using an industrial lens, and the image information is in one-to-one correspondence with the spectral information.

3. The coal gangue recognition method based on visible-near-infrared spectrum and image multi-modal information fusion according to claim 1, wherein in step S2,
preprocessing the spectral information comprises:
sequentially subjecting to existing technical processing of black and white correction, initial and final band elimination, SG smoothing and standard normal variate transformation; and
preprocessing the image information comprises:
uniformly adjusting an image size, converting an image with an adjusted size into a tensor format, and performing standardization processing on the image.

4. The coal gangue recognition method based on visible-near-infrared spectrum and image multi-modal information fusion according to claim 1, wherein in step S2, preprocessed spectral features and image features are in one-to-one correspondence, and are encapsulated together with labels in TensorDataset.

5. The coal gangue recognition method based on visible-near-infrared spectrum and image multi-modal information fusion according to claim 1, wherein in step S3,
the spectral feature extraction neural network model comprises:
a recurrent neural network branch, comprising: an LSTM layer, a batch normalization layer, and an expansion layer, wherein the spectral information is sequentially subjected to the LSTM layer and the batch normalization layer for expansion to obtain spectral sequence features; and
a convolutional neural network branch, comprising: a one-dimensional convolutional layer, a maximum pooling layer, and a Dropout layer, wherein the spectral information is subjected to the one-dimensional convolutional layer, the maximum pooling layer and the Dropout layer to obtain spectral convolutional features,
wherein the spectral sequence features and the spectral convolutional features are subjected to Concat operation for fusion and then input into a second convolutional layer and a Relu layer to obtain the spectral features.

6. The coal gangue recognition method based on visible-near-infrared spectrum and image multi-modal information fusion according to claim 1, wherein in step S3,
the image feature extraction neural network model comprises convolutional blocks, 17 inverted residual blocks, and a convolutional block cascade, each convolutional block comprises a two-dimensional convolutional layer, a batch normalization layer, and a Relu6 layer, and each inverted residual block comprises a lightweight dilated convolution layer, a depthwise separable convolution layer, and a pointwise convolution layer.

7. The coal gangue recognition method based on visible-near-infrared spectrum and image multi-modal information fusion according to claim 1, wherein in step S4, the two-stream fusion network comprises:
a first convolutional branch, comprising: a convolutional layer, a batch normalization layer, and a convolutional layer, wherein the spectral features are input into the first convolutional branch, and spectral feature 1 is output;
a second convolutional branch, comprising: a convolutional layer, a batch normalization layer, and a convolutional layer, wherein the image features are input into the second convolutional branch, and image feature 1 is output;
a third convolutional branch, comprising: a convolutional layer and a batch normalization layer, wherein the spectral features are input into the third convolutional branch, and spectral feature 2 is output;
a fourth convolutional branch, comprising: a convolutional layer, a batch normalization layer, and an average pooling layer, wherein the image features are input into the fourth convolutional branch, and image feature 2 is output; and
a self-attention mechanism, wherein the spectral feature 2 and the image feature 2 are subjected to the self-attention mechanism to obtain weight distribution of original features in a fusion feature space,
wherein the spectral feature 2 and the image feature 2 are subjected to multiplicative fusion to obtain fusion feature 1, the spectral feature 2 and the image feature 2 are used to be respectively subjected to multiplicative fusion with the fusion feature 1, concatenation operation is then performed, normalization is performed in a global feature, a normalized feature weight is used to be respectively multiplied by the spectral feature 1 and the image feature 1 to obtain a spectral weight feature and an image weight feature under guidance of the fusion feature space, and two modal weight features are subjected to additive fusion to obtain the comprehensive feature which is then subjected to convolution processing once to obtain a deeper-layer comprehensive feature.

8. The coal gangue recognition method based on visible-near-infrared spectrum and image multi-modal information fusion according to claim 1, wherein in step S5:
the spectral branch classifier comprises: a fully connected layer and a Sigmoid layer;
the image branch classifier comprises: an adaptive average pooling layer and a 1*1 convolutional layer; and
the fusion branch classifier comprises: two fully connected layers connected, wherein an activation function is Relu.

9. The coal gangue recognition method based on visible-near-infrared spectrum and image multi-modal information fusion according to claim 1, wherein step S6 comprises:
training, based on the image-spectrum data set, a neural network model constituted by the spectral feature extraction neural network model, the image feature extraction neural network model, the two-stream fusion network, the spectral branch classifier, the image branch classifier and the fusion branch classifier to obtain accuracy rates, F1 values and root-mean-square errors under the spectral branch classifier, the image branch classifier and the fusion branch classifier, which are taken as priori knowledge;
constructing a target layer, an index layer and a scheme layer according to coal gangue sorting requirements and scenarios, wherein the target layer is for coal gangue sorting, the index layer is for classed accuracy rates, F1 values and root-mean-square errors, and the scheme layer is for the spectral branch classifier, the image branch classifier and the fusion branch classifier;
judging importance of each index in the index layer relative to a task according to scenarios and requirements of the task, thereby formulating a judgment matrix between the target layer and the index layer to finally obtain a 3×3 judgment matrix, wherein a judgment matrix element Dᵢⱼ represents an importance degree of an ith-row factor relative to a jth-column factor, the larger a numerical value thereof is, the more important a factor is, and row and column factors are the accuracy rates, the F1 values and the root-mean-square errors, respectively;
dividing the priori knowledge, i.e., the accuracy rates, the F1 values and the root-mean-square errors under the spectral branch classifier, the image branch classifier and the fusion branch classifier, into 9 sections on average according to a maximum value and a minimum value of each index, wherein the closer an index of a classifier is to an optimal value, the larger a quantization value, representing the importance degree of the index of an ith-row classifier relative to a jth-column classifier, and row and column classifiers represent the spectrum branch classifier, the image branch classifier and the fusion branch classifier, respectively; and performing operations above on each index to finally obtain three 3×3 judgment matrices;
obtaining factor weight matrices between the target layer and the index layer as well as between the index layer and the scheme layer by calculation using an eigenvalue method according to the judgment matrices, and constituting a final classifier weight matrix by the factor weight matrices; and
checking whether the judgment matrices pass consistency check, if yes, subjecting a first column and last three columns of the final classifier weight matrix to multiply-accumulate operation correspondingly to obtain an importance weight of each classifier, and if not, verifying that the judgment matrices are set incorrectly, and reconstructing judgment matrices.

10. The coal gangue recognition method based on visible-near-infrared spectrum and image multi-modal information fusion according to claim 1, wherein step S7 comprises:
subjecting three class confidence matrices output by the spectrum branch classifier, the image branch classifier and the fusion branch classifier and a classifier weight matrix to multiply-accumulate operation to finally obtain scores predicted to be coal and gangue, thereby achieving coal gangue recognition.
